(19) United States
(12) Patent Application Publication
(10) Pub. No.: US 2010/0164230 A1
(43) Pub. Date: Jul. 1, 2010

(54) Installation for harvesting ocean currents (IHOC) and methods and means for its delivery, installation and servicing

(76) Inventors: Sidney Irving Belinsky, West Palm Beach, FL (US); Aleksey Belinskiy, Cherry Hill, NJ (US)

Correspondence Address: ALEKSEY BELINSKIY, 505 COLUMBIA BLVD, CHERRY HILL, NJ, 08002, US

(21) Appl. No.: 12/655,198

(22) Filed: Dec. 24, 2009

Related U.S. Application Data
(60) Provisional application No. 61/203,853, filed on Dec. 29, 2008.

(51) Int. Cl. F03B 13/00

(52) U.S. Cl. 290/54

(57) ABSTRACT

Installation for harvesting energy of ocean currents (IHOC) in deepwaters is based on utilization of a semisubmersible platform and the multiple of vertically oriented Darrieus type hydraulic turbines. The turbines are located as close as possible to ocean surface, where speed of current is usually at its maximum. Since speed of current fluctuate during the seasons a system controlling buoyancy force of that keeps IHOC floating near surface is employed. The mooring system consists of three tethers, which prevent transferring of overturning moment applied to IHOC to anchoring base. The electric power generators are located in a machinery room on a structure well above sea level and would transmit electric power to the shore utilizing flexible cable. During hurricane it will be lowered to the depth preventing turbines from being affected by wave actions, at the same time it would keep machinery room above wave action. For the purpose of delivery assembled on shore Turbine Housing to destination site and installing it there a special convoy is formed consisting of Catamaran Delivery Barge and Stabilizing Platform.

The second Embodiment of this invention is designed to harvest energy of tides in deepwaters.

### RELATED APPLICATION

This Application claims priority from Provisional Patent Application No. 61/203,853 filed Dec. 29, 2008, disclosure of which is incorporated herein by reference.

### FIELD OF THE INVENTION

This invention relates to harvesting kinetic energy of ocean currents and tides in deepwaters.

### PRIOR ART

The U.S. Pat. No. 6,856,036 issued Feb. 15, 2005 to Belinsky, who is also one of two authors of this application, describes Installation for Harvesting Ocean Current (IHOC), which innovation is based on the use of anchored to seabed semisubmersible platform having underwater frame containing at least two vertically oriented rows of Darrieus type turbines and in its capability to keep the semisubmersible platform in vertical position by automatically adjusting the length of one pair of the mooring lines, which change in the length depends on the speed of the current. The Darrieus turbines have vertically oriented central shaft that allows locating machinery room above water level and by this excludes the problem of flooding the machineries rooms of the system utilizing horizontal propeller type turbines. The prior patent has three embodiments, one of which is for harvesting energy of tides in deepwaters.

### OBJECTIVES

The objectives of the instant invention are in the improvements of the capabilities of the second and third embodiment of the patented IHOC.

The first of improvements is in elimination of the need for an automatically operating system for adjusting the length of mooring lines to keep IHOC being oriented always perpendicular to current, because the daily and seasonable change in the current speed, affects the length of the mooring lines.

The second improvement is in the added capabilities for IHOC for having turbines placed near surface to maximize utilization of the current energy and to sink them significantly below the zone of wave's action, thus avoiding their distraction during severe stormy weather means.

The third improvement is in introduction of the means and method of lifting Turbine Housing from Assembling Yard, transporting it in horizontal position in a convoy, which includes also Stabilizing Platform and Anchoring Base, to the designated point, where Anchoring Base is lowered on seabed and Turbine Housing tilts into vertical position and by this completing IHOC installation.

The fourth improvement is in the means that allows maintenance personnel to board IHOC during stormy seas.

The fifth improvement is in the means that allows on the regular basis to clean turbines blades from foulings on their surface, which, if not remove timely, increase their drag and by this noticeable reducing turbines efficiency.

### SUMMARY OF THE INVENTION

The objectives of the instant invention are achieved through the following innovations:

### 1. Mooring System.

The new mooring system proves to IHOC two advantages:
A. The improved IHOC is moored to Anchoring Base on the ocean floor by three equal length tethers forming parallelogram, which keep IHOC in vertical position and perpendicular to current direction regardless to the change in the current speed, force and in the length of its horizontal displacement.
B. The three tethers anchoring arrangement attached to the middle of submerged structure excludes transferring wind and waves moments acting on IHOC to Anchoring Base, by compensating these moments through buoyancy force of IHOC submerged structure and a lever equal to perpendicular from the center of buoyancy to any of three possible axis of IHOC rotation.

### 2. Anchoring Base.

Correspondingly to three tethers mooring systems the Anchoring Base is in a form of triangle structure. The new IHOC Anchoring Base is using on its three ends suction buckets, which generates holding power sufficient to substitute gravity mass used by patented IHOC Gravity Anchoring Base. It also has three cones, which are positioned near the Anchor Base center and serve as temporally storage for the tethers during delivery of Anchoring Base to destination site.
   3. Means and Method for Delivery IHOC from Assembling Yard to Destination Site and its Installation There.
The means includes Catamaran Delivery Barge, set of three carriages and a Stabilizing Platform. The method consists of sequence of operation of moving Turbine Housing supported by three carriages from Assembling Yard to piers, engaging Catamaran Delivery Barge with piers, lifting Turbine Housing from carriages, floating Catamaran Delivery Barge with Turbine Housing on it out into open seas, forming convoy consisting of Catamaran Delivery Barge with Turbine Housing, Anchoring Base and Stabilizing Platform between them. After convoy arrives to destination site the installation of IHOC in final position includes steps of lowering Anchoring Base to the seabed including Stabilizing Platform mitigation of the impact between Anchoring Base and seabed, activation of suction buckets and their penetration in seabed, transferring Catamaran Delivery Barge into semisubmersible mode at which Turbine Housing starts to float on its own. After that Catamaran Delivery Barge moves away and Turbine Housing takes ballast in its lower part, which start to tilt it and by this expose itself to current force, which accelerates the tilting of Turbine Housing. When Turbine Housing comes to vertical position all three tethers becomes automatically equally tensioned and on this process of installing IHOC is finished.

### 4. Means for Controlling IHOC Submerged Position.

The purpose of these means is to keep turbines as closed as possible to surface, where the speed of current is always at its maximum and during severe storms to lower them on a significant distance from the ocean surface, which would mitigate force of wave's dynamic force acting on the turbines. This is achieved by controlling the buoyancy force of IHOC. For this purpose the entire structure of IHOC, consists of pipes and tubes forming a vessel that floats. One part of its structure internal volume is used as storage for compressed air and other part of its structure internal volume is used for controlling its buoyancy force by changing water level in it by opening and closing valves and increasing or lowering pressure of compressed air above water level inside this vessel. Thus allows IHOC, besides keeping it floating near surface during seasonal variation of current speed, to sink on a significant depth below ocean surface during hurricane and to keep its machinery Room above stormy waves.

### 5. Means for Delivery Maintenance Personnel to IHOC.

For the purpose of allowing maintenance personnel to board IHOC even during stormy seas, the Turbine Housing has an Arrangement consisting of boarding platform and at least three equally spaced cone-adapter. This allows the special Service Vessel to engage its gangway with cone-adopter and by this providing safe condition for maintenance personnel to pass to boarding platform.
   6. Means for Cleaning Turbine Blades from Foulings.
For the purpose of preventing significant losses in turbines efficiency the improved IHOC provides means for periodical cleaning turbine blades from foulings. These means includes on Turbine Housing guiding poles and rails for a special Blade Cleaning System. This system consists of winch platform and operating platform, which is suspended on four ropes from winch platform and can move vertically along the Turbine Housing. Operating platform has two blade cleaning machines, which can be engaged simultaneously with each of two vertical rows of turbines. Each blade cleaning machine has two arms with cleaning heads on their ends, which allows simultaneously cleaning both sides of turbine blade.

There are two preferred Embodiment of improved IHOC. Embodiment A is designed to harvest energy of current, Embodiment B is designed for harvesting tides.

### BRIEF DESCRIPTION OF DRAWINGS

FIG. 1—IHOC in operating position (Elevation).

FIG. 2—IHOC in operating position (Plan).

FIG. 3—Turbines Assembly General Arrangement (Elevation).

FIG. 4—Turbines Assembly General Arrangement (Side View).

FIG. 5—Turbines Assembly General Arrangement (Plan).

FIG. 6—Section A-A from FIG. 4

FIG. 7—Section B-B from FIG. 4

FIG. 8—Section C-C from FIG. 4

FIG. 9—Detail I from FIG. 3.

FIG. 10—Plan View from FIG. 9.

FIG. 11—Detailed II from FIG. 3.

FIG. 12—Plan View from FIG. 11.

FIG. 13—Detail III from FIG. 4.

FIG. 14—Section D-Detail from FIG. 13.

FIG. 15—Section E-E from FIG. 13.

FIG. 16—Anchoring Base (GAB); Elevation.

FIG. 17—Anchoring Base (GAB); Plan.

FIG. 18—Stabilizing Platform (Elevation).

FIG. 19—Stabilizing Platform (Plan).

FIG. 20—Section through IHOC Assembling Yard.

FIG. 21—Plan of Assembling Yard.

FIG. 22—Turbines Assembly moved on piers.

FIG. 23—Catamaran Delivery Barge engaged with piers.

FIG. 24—Section F-F from FIG. 23.

FIG. 25—Catamaran Delivery Barge with TLP moved from piers (Elevation).

FIG. 26—Catamaran Delivery Barge with TLP moved from piers (Plan).

FIG. 27—IHOC Convoy during transportation (Elevation).

FIG. 28—IHOC Convoy during transportation (Plan).

FIG. 29—IHOC Convoy at installation site.

FIG. 30—Process of lowering Gravity Anchoring Base (1).

FIG. 31—Process of lowering Gravity Anchoring Base (2).

FIG. 32—Process of lowering Gravity Anchoring Base (3).

FIG. 33—Process of lowering Turbine Housing in water

FIG. 34—Catamaran Delivery Barge moves away from Turbines Assembly.

FIG. 35—Process of Turbine Housing inverting in vertical position (1).

FIG. 36—Process of Turbine Housing inverting in vertical position (2).

FIG. 37—Turbine Housing in vertical position (3).

FIG. 38—IHOC Group Installation (Elevation).

FIG. 39—IHOC Group Installation (Plan).

FIG. 40—System for cleaning turbine blades from foulings.

FIG. 41—Detail IV from FIG. 40.

FIG. 42—Plan from FIG. 41.

FIG. 43—Section H-H from FIG. 40.

FIG. 44—Service Vessel at IHOC (Elevation).

FIG. 45—Service Vessel at IHOC (Plan).

FIG. 46—Section L-L from FIG. 3.

FIG. 47—IHOC—Embodiment B.

### DETAILED DESCRIPTION OF THE INVENTION

### EMBODIMENT A

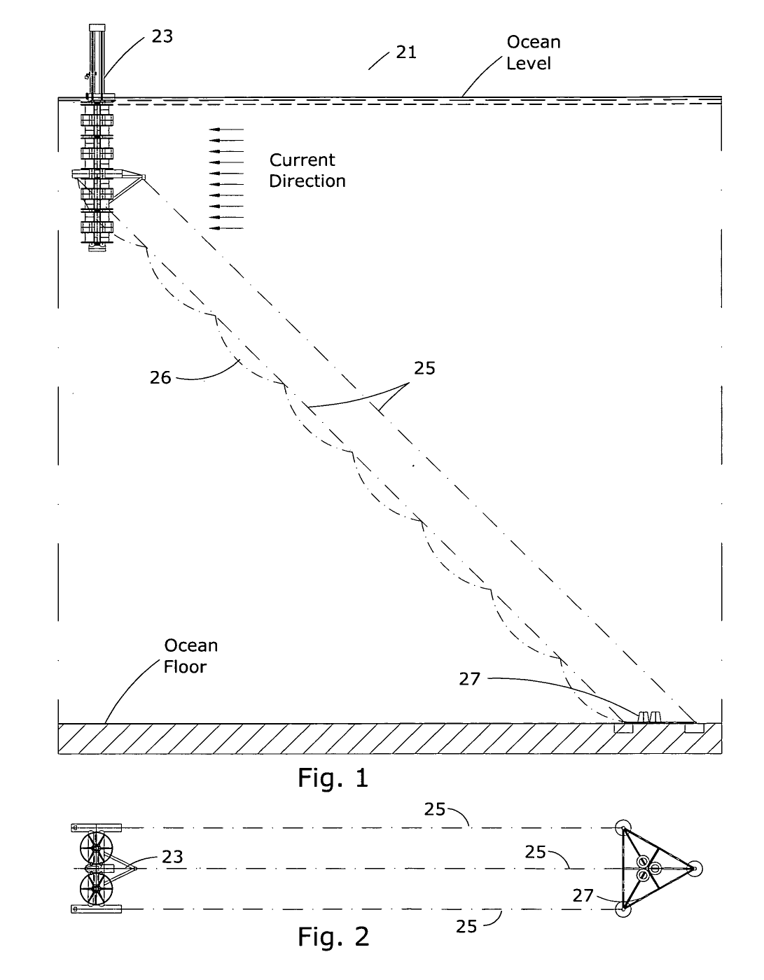

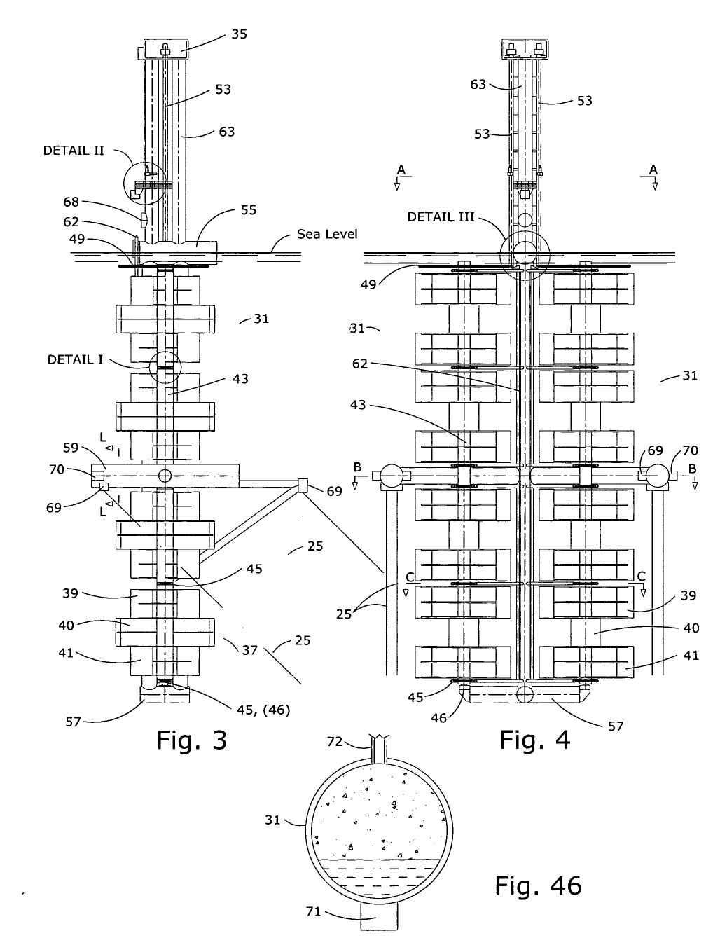

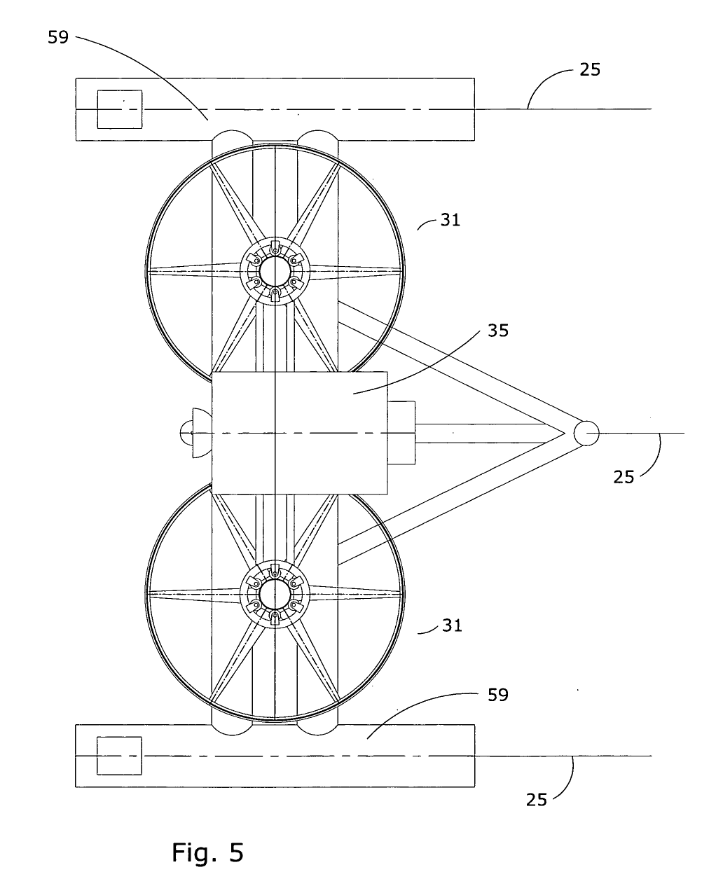

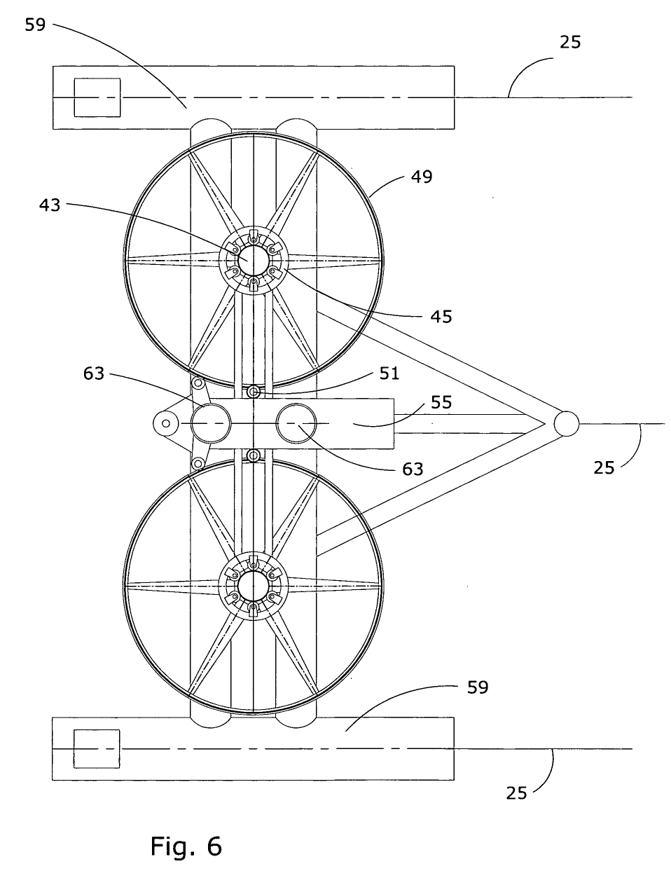

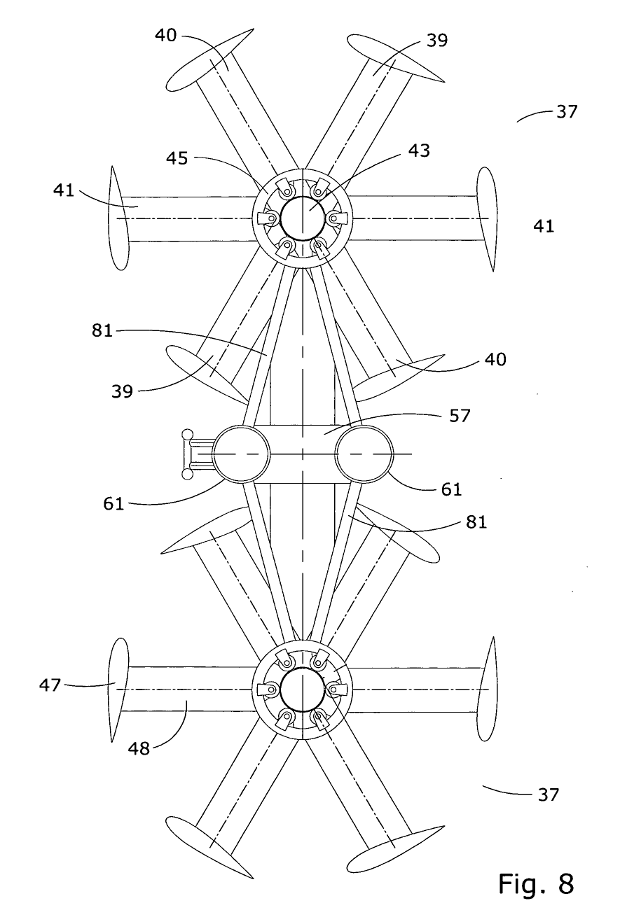

FIGS. 1 and 2 show general arrangement of the IHOC in installed position. The IHOC 21 consists of Turbines Assembly 23, four tethers 25, power cable 26 and Anchoring Base (AB) 27. The power cable 26 on its way from the IHOC bottom to gravity anchoring base is connected in several places to one of the tethers. The gravity-anchoring base 27 would have means connecting it to power cable going to the shore. FIGS. 3 through 12 illustrate design of Turbine Housing 23, it consists of two vertical rows 31 of Darrieus turbines, frame 33 and machinery room 35. It also includes a system 36 for controlling Turbine Housing 23 buoyancy force during its submerged position. Each row 31 of Darrieus turbines contains four turbines 37. Each turbine 37 consists of three two blades turbines 39, 40 and 41, shifted in plane on 120 degrees and attached to a common vertical shaft 43, which is supported from horizontal displacement by bearing arrangements 45 located between turbines 37 and from vertical displacement by trust bearing 46 located on the lower pontoon 57. Each two blade turbine has two blades 47 and two spokes 48. To the top of vertical shaft 43 is attached gear wheel 49, which is engaged with tooth gear 51. Gear 51 is attached to a vertical power shaft arrangement 53, which is going upward to machinery room 35.

Frame 33 consists of upper pontoon 55, lower pontoon 57 and middle pontoon 59, two vertical columns 61 connecting upper and lower pontoons 55 and 57, and machinery support column 63 all of which are pipe type structures with hollow inside. To one of the columns 61 are attached two rails 62 for guiding Blade Cleaning System. The middle pontoon 59 consists of two side pontoons 65 and 66, two cross pontoons 67 and tripod support 67A. Tripod support 67A has on its front end bottom one tether 25 attachment 69. Each side pontoons 65 and 66 have on the bottom of their rear ends has one tether 25 attachment 69. These three tether 25 attachments form a triangle area center of which coincides with IHOC center of buoyancy.

For transportation purposes the Turbines Assembly 23 has front trust point 68 and pair of middle trust points 69 and 70.

The system 36, which controls Turbine Housing 23 buoyancy force, includes the inner space of side pontoons 65 and 66, which are partially field with water and compressed air (see FIG. 47, sheet 2). The proportion of water and compressed air inside them is achieved through compressed air outfit 71 and remote operated valve 72, which allow water to flow out or inside pontoons 65 and 66. The system 36 also includes the inner space of lower pontoon 57 as storage for compressed air. Machinery Room 35 will include two generators, compressors and controls post, which are not shown.

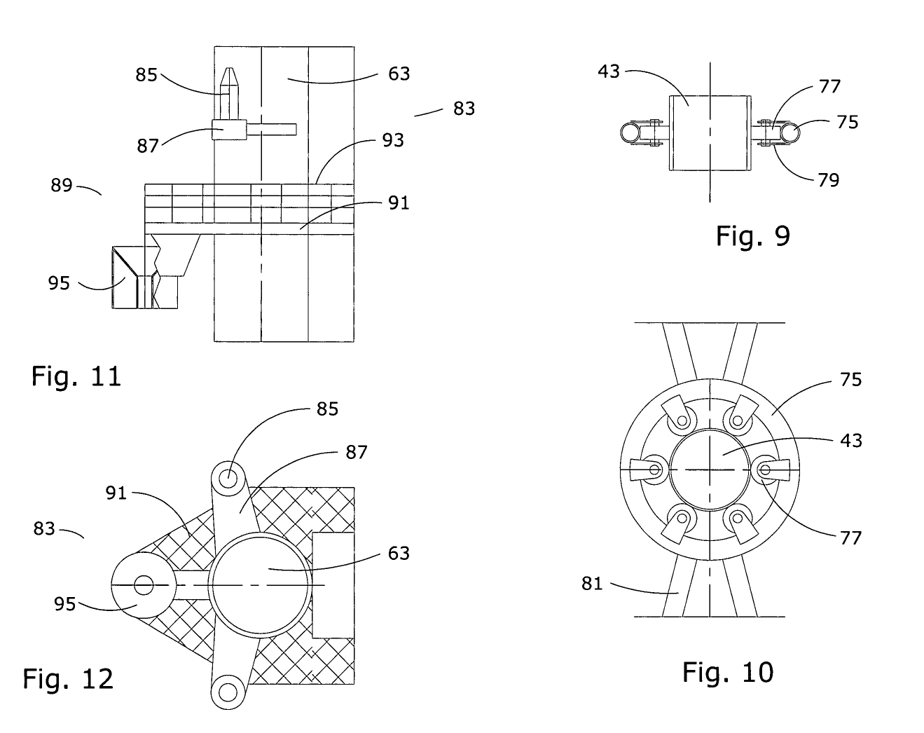

FIGS. 9 and 10 illustrate bearing arrangements 45, which provides horizontal supports vertical shaft 43 along its height by at least two units per turbine. Each unit 45 consists of ring base 75, at least three equally spaced roller 77 with supports 79. Each ring base 75 is connected to vertical supports 61 by at least two beams 81.

FIGS. 11 and 12 illustrate Arrangements for attaching Service Vessel 179 and Blade Cleaning System 180 to IHOC 21. Base 83 for attaching to IHOC Blade Cleaning System consists of symmetrically located pair of vertical poles 85 with cone head and a support 87. The Arrangement 89 for attaching Service Vessel 179 Personnel Transfer Station 181 to IHOC 21 consists of boarding platform 91, hand rails 93 and an open cone-adapter 95.

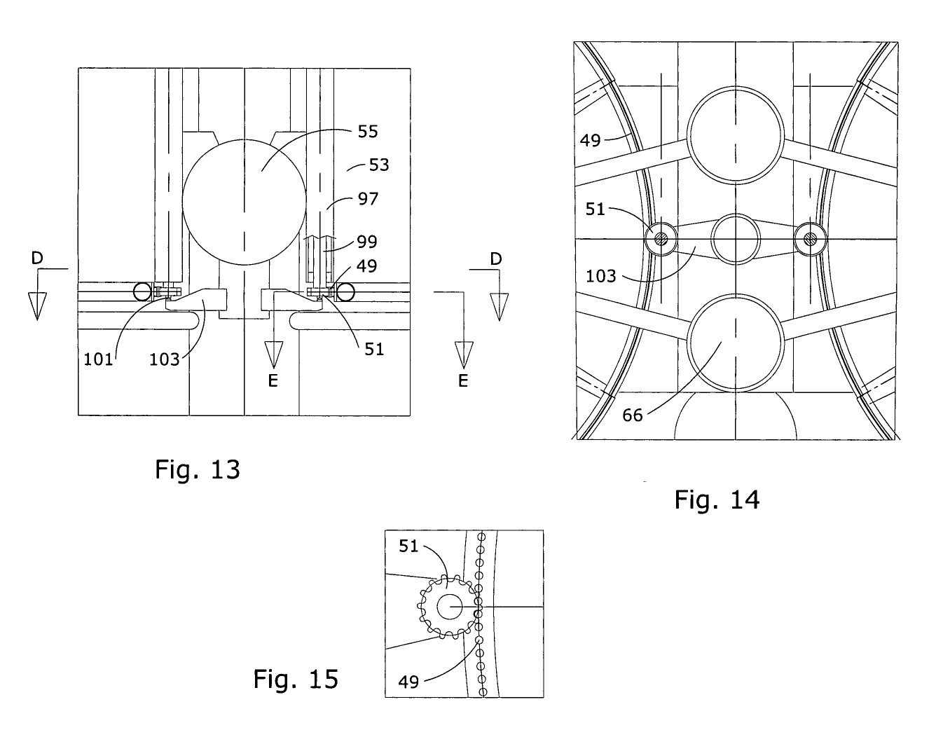

FIGS. 13 through 15 illustrate engagement of gear wheel 49 with vertical power shaft arrangement 53, which consists of vertical tube 97, shaft 99, tooth gear 51 and trust bearing 101 with support 103 attached to upper pontoon 55.

### Anchoring Base.

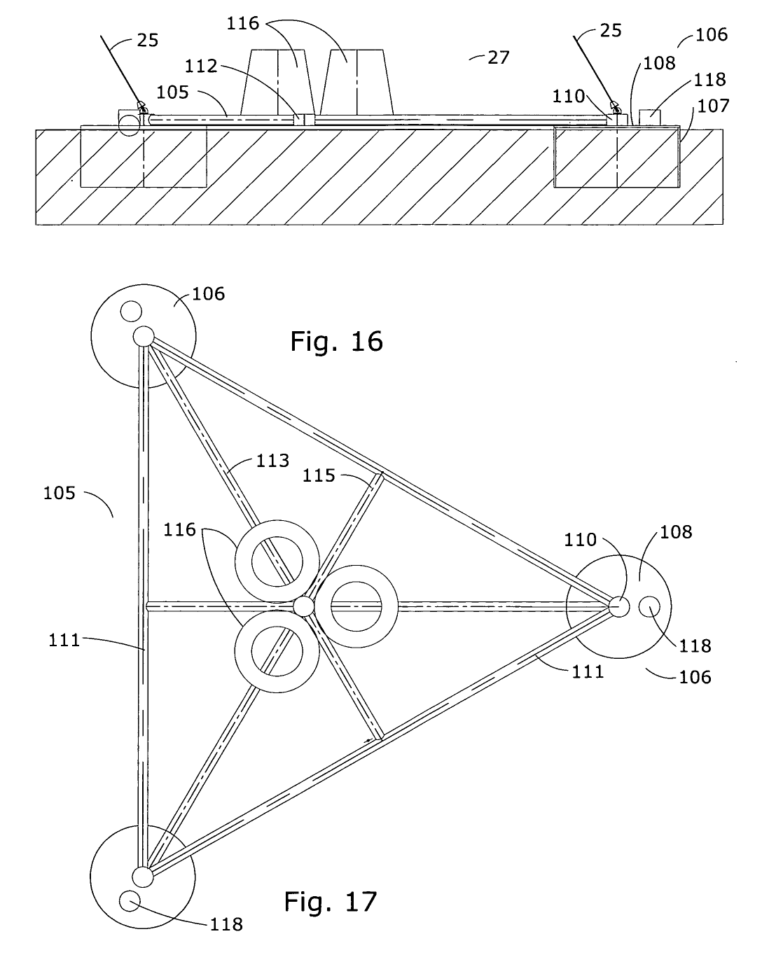

FIGS. 16 and 17 Illustrate Anchoring Base 27 positioned on the ocean floor. It consists of a frame 105, three suction buckets 106, each consisting of a cylinder 107, top plate 108 and connector 110. All suction buckets 106 are interconnected by three beams 111 through connectors 110 forming triangle structure. In the center of triangle structure is positioned central ring 112, which serves as a hub to which beams 113 and 114 are attached. Near center ring 112 are located equally spaced three cones 116, which serve as a storages for tethers 25 during Anchor Base 27 transportation to destination site. Location of three tethers 25 attachment points forms a triangle, which area center coincides with Anchoring Base geometrical center. Each suction bucket 106 has an electric pump 118 with the capability to be disconnected after suction bucket is fully immersed into seabed soil and flowing up to ocean level.

### Stabilizing Platform.

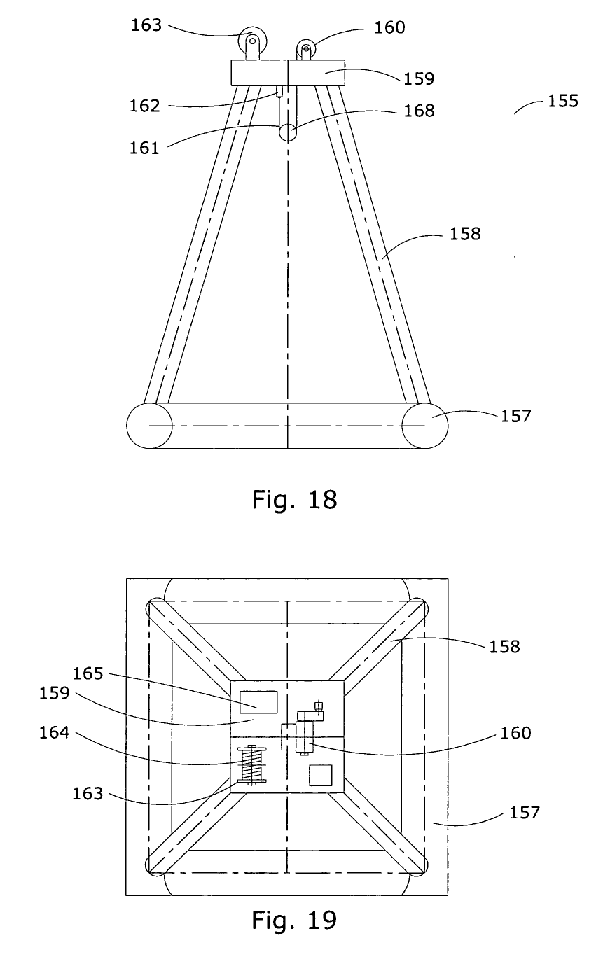

FIGS. 18 and 19 illustrate design of stabilizing platform 155, which provides conditions for the Anchoring Base 27 to descend and land flat on the ocean floor. It also provides to Anchoring base 27 electric powers to operate their suction pumps. It consists of a pontoon 157, four legs 158, winch platform 159, winch 160, hoisting line 161 and hoisting line quick release device 162. It also includes electric power cable drum 163 with cable 164, electric power generator 165 and control post 166.

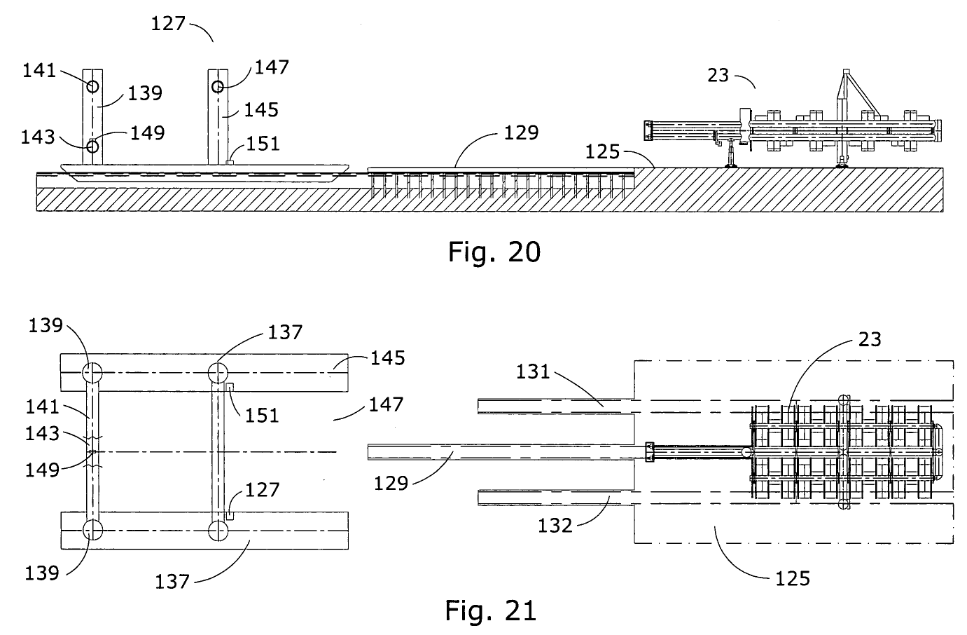

FIGS. 20 and 21 illustrate Catamaran Delivery Barge 127 and Assembling Yard 125, which expands into three piers one central 129 and two side piers 131. Turbine Housing 23 is positioned on three carriages, one central carriage 133 and two side carriages 135.

### Catamaran Delivery Barge.

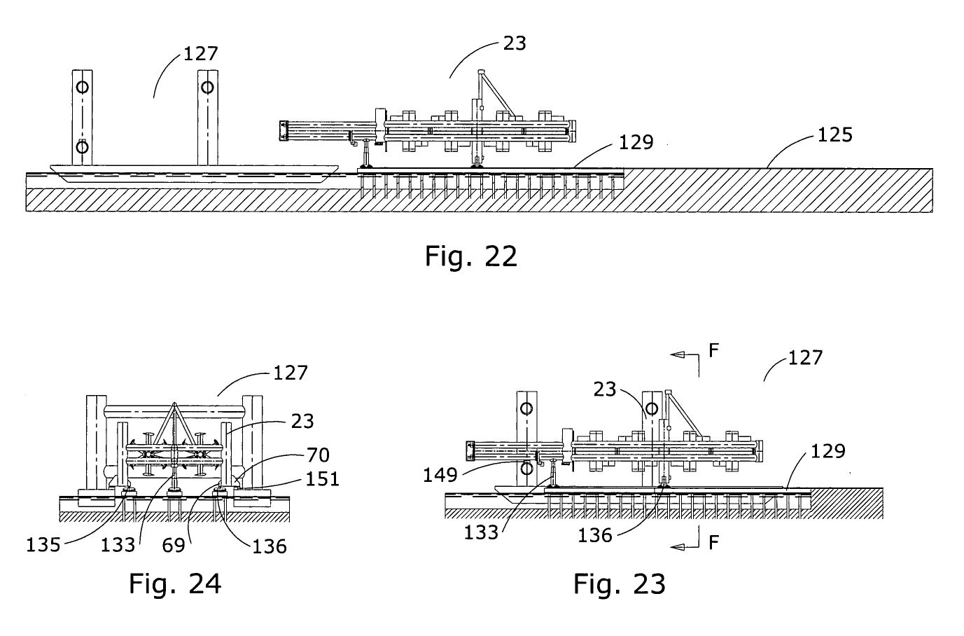

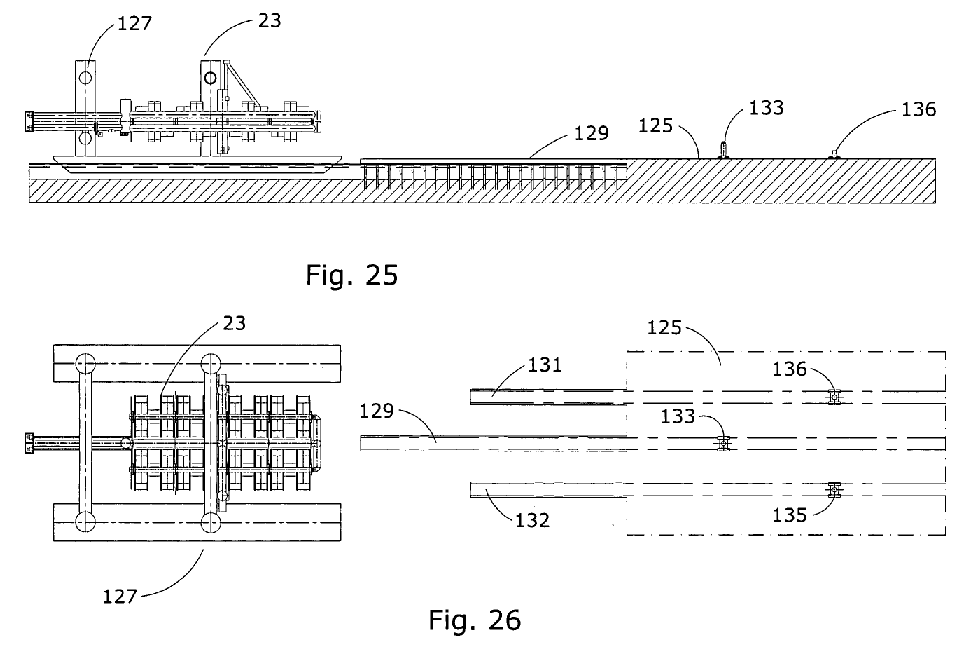

Catamaran Delivery Barge 127, see FIGS. 22 through 25, consists of two pontoons 137 each having rear upward extended columns 139 and two upward extended columns 140 near the middle of pontoons 137. Two rear upward extended columns 133 are interconnected by two crossbeams upper 141 and lower 143. The rear upward extended columns 140 are interconnected by only one crossbeam 145. For the purpose of engaging with Turbine Housing Catamaran Delivery Barge 127 has three points of contact, one of point of contacts is a support pillow 149, which is located on the middle of Crossbeam 143, and two points contacts in the form of support stools 151 (see FIG. 24), located on both pontoon 137 in the area near the rear extended upward columns 140. Inside of extended upward columns 140 would be located compressors and control posts, which are not shown.

The Process of Transferring Turbine Housing from Assembly Yard to Catamaran Delivery Barge.

The process starts by relocating Turbine Housing 23 from Assembling Yard 125 to piers 129 and 131 using carriages 133, 135 and 136, which support Turbine Housing at three trust points—one 68 and two 70. FIG. 22 illustrates Turbine Housing already moved on the pier 129 and piers 131 from the Assembling Yard 125.

Catamaran Delivery Barge 127, before approaching Turbine Housing 23 on the piers, takes ballast to sunk to the depth that would position its engagement points (149, 135 and 136) below the engagement points (one 68 and two 70) on the Turbine Housing. The Catamaran Delivery Barge 127 movement toward the Turbine Housing 23 would stop after its engagement points (149, 135 and 136) would match the corresponding engagement points (one 68 and two 70). At this position Catamaran Delivery Barge starts to refloat and, after supports stools 151 and support pillow 149 got in contact with trust point 68 and two trust points 70 on Turbine Assembling 23, would lift Turbine Housing 23 from carriages 133, 135 and 136. By next step Catamaran Delivery Barge 127 with Turbine Housing on it moves out of piers area, which illustrated by FIGS. 23 and 24.

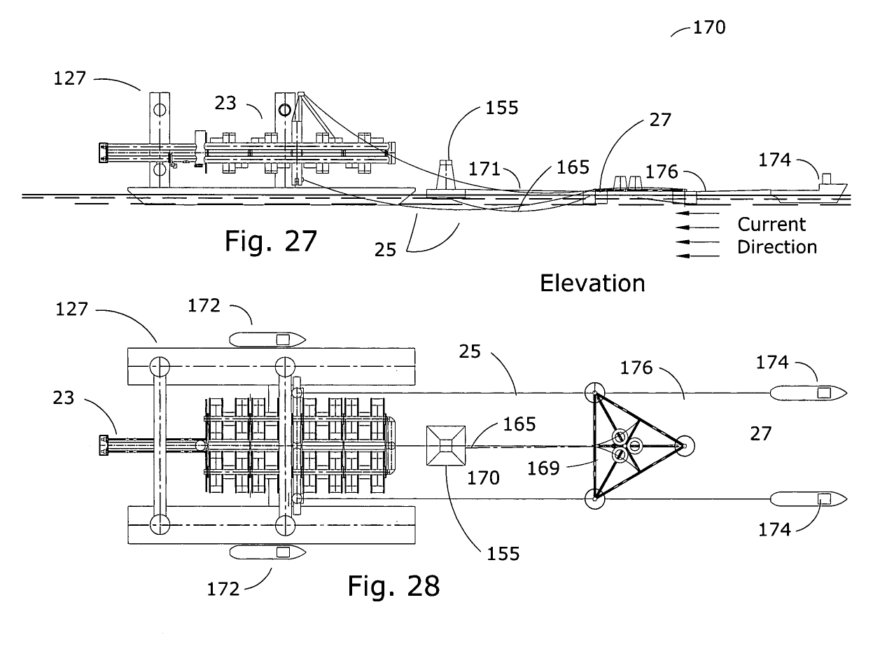

The process of assembling convoy for towing Turbine Housing 23 to installation side. FIGS. 27 and 28 illustrate assembled Convoy 170 for towing Turbine Housing 23 to destination site, which consists of Catamaran Delivery Barge 127, Anchoring Base 27, floating on compressed air filled in the suction buckets 106, and Stabilizing Platform 155. At the first the Stabilizing Platform 155 would be attached to Anchoring Base by hoisting line 161 and electric cable 163. After this the upper ends of three tethers 25, which are stored on Anchor Base 27 cones 116, would be connected to the Turbine Housing three points of contact 69 with some slack in each of them. These connections would allow tugs 172 to tow Turbine Housing 23 and group of tugs 174 to tow, through towing lines 176, the interconnected Anchoring Base 27 and Stabilizing Platform 155 simultaneously together as a Convoy 170. The slackened tethers 25 would allow compensating for minor variation in the speed of tugs in group 172 and 174.

### The Process of Installing IHOC at the Destination Site.

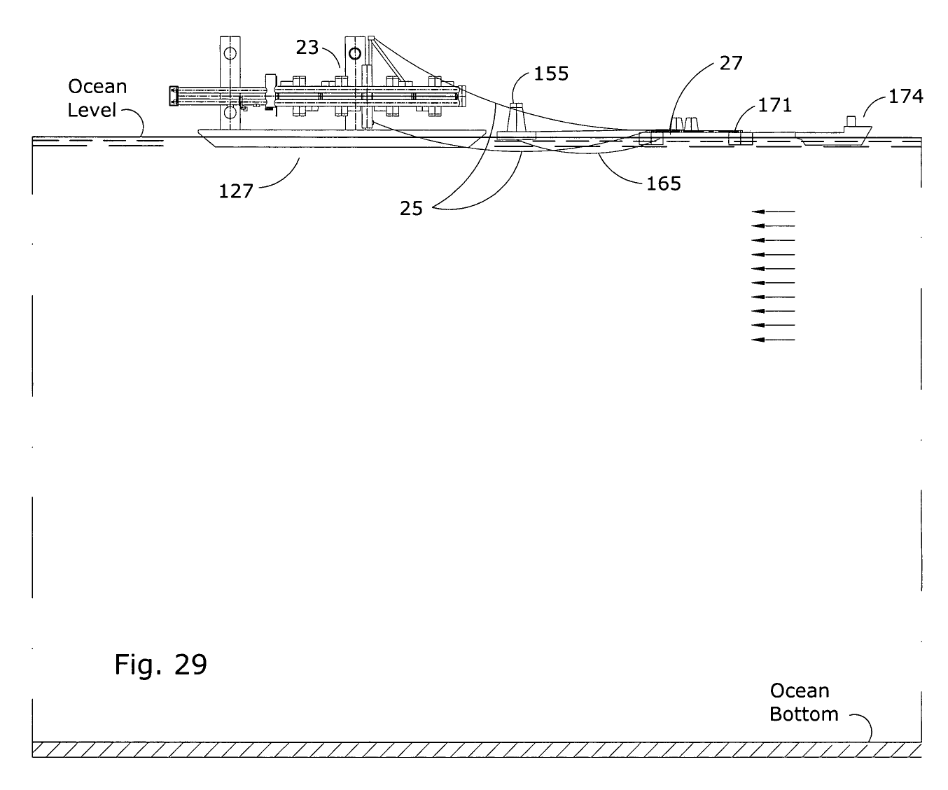

FIG. 29 illustrates Convoy 170 arrived to destination point. At this position tugs 172 and 174 would keep all convoy 170 stalled by working only against the current.

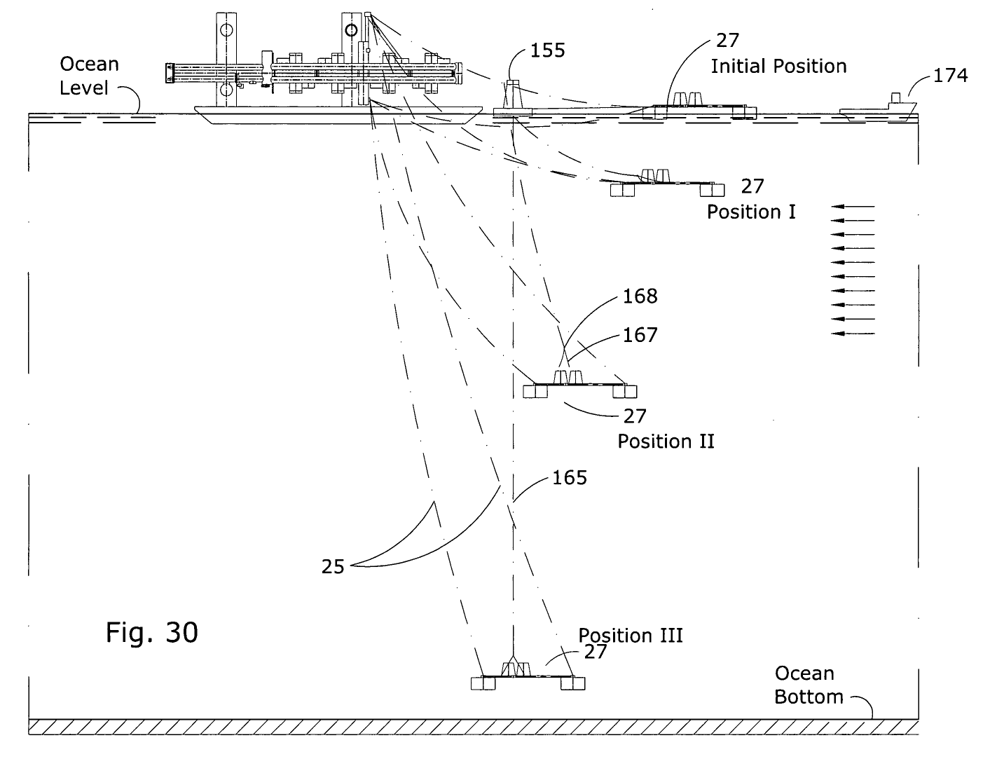

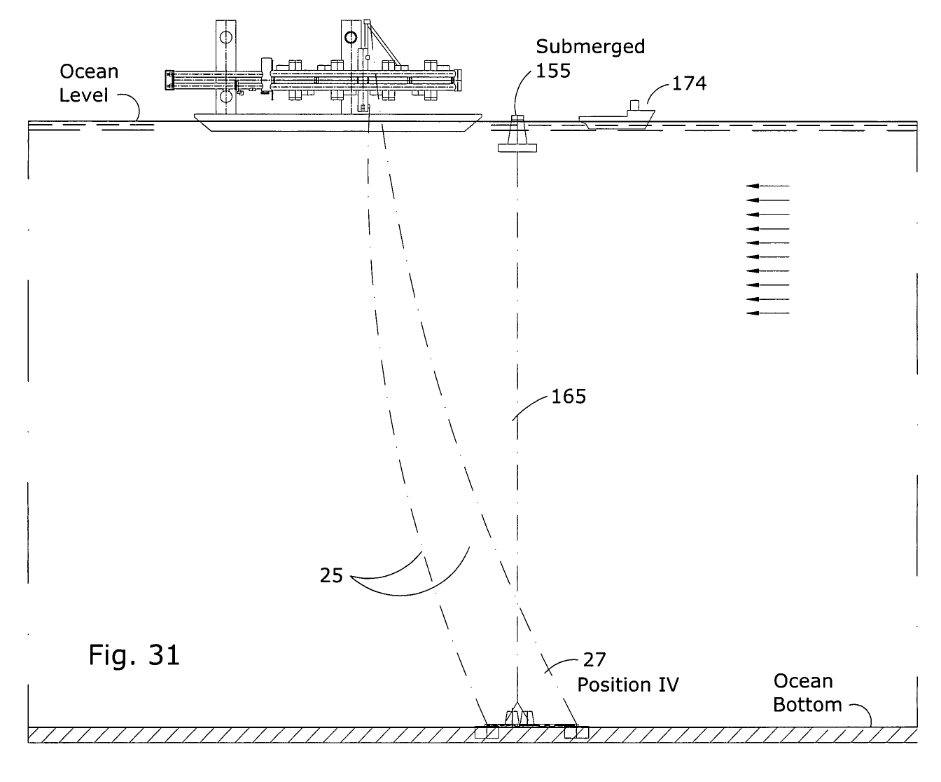

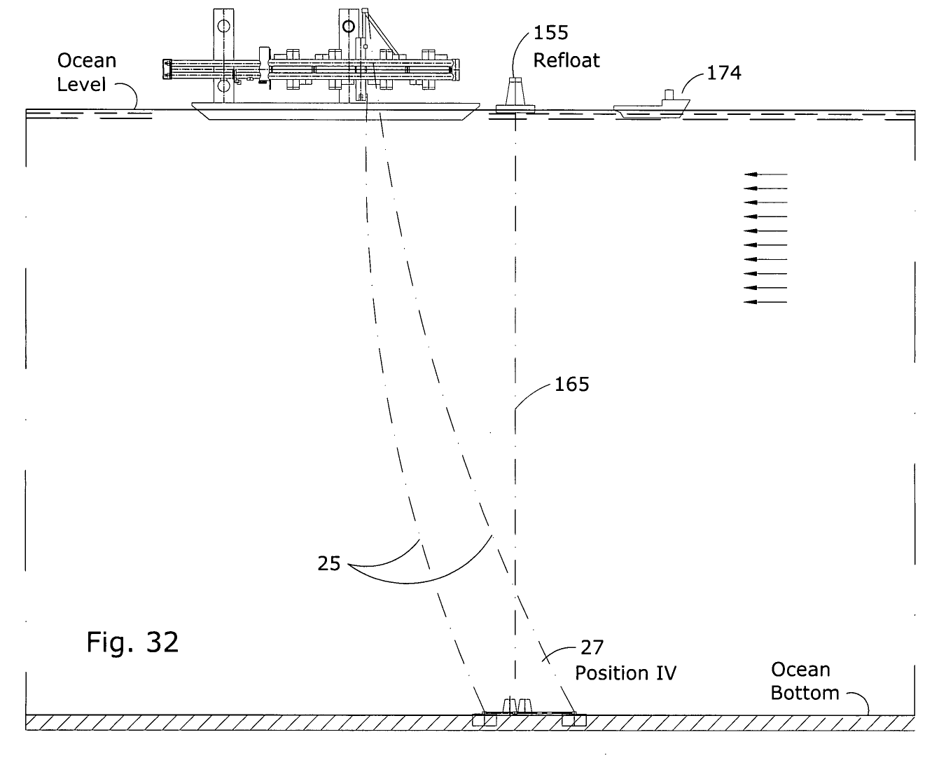

FIGS. 30 through 32 illustrate the process of lowering Anchoring Base 27 to ocean bottom, which consists of the following steps:
At the initial position Anchoring Base 27 starts to vent compressed air from suction bucket 106 and this initiates it sinking.
During sinking it would tension hoisting line 161 through a sling 167 and a sheave 168 (see FIG. 30) to a certain level after which winch 160 would starts to payout hoisting line 161 under some tension, which would keep Anchoring Base 27 horizontal position during the controlled decent.
About 10 meters before reaching ocean bottom the winch 160 stops paying out and this would pull down Stabilizing Platform 155 down. The increased force in hoisting line 161 would further stabilize Anchoring Base 27 horizontal position.
When Anchoring Base 27 reaches the ocean bottom and suction buckets 106 would start penetrating soil under their own weight the Stabilizing Platform 155 would slack the hoisting line and by this Stabilizing Platform 155 would gradually refloat to initial position. Simultaneously the electric pumps 118 on Anchoring Base 27 would start pump out water from suction buckets 106 and by this pressing them further into soil.
After suction buckets 106 would be completely inserted in soil the command would be sent to electric pumps 118 to disconnect from Anchoring Base 27 and flow up. Simultaneously would be given command to activate the quick release device 167, which would be released one end of hoisting line 161, which would let sheave 163 and sling 162 to free fall and would allow the winch 160 will pull up the remaining length of hoisting line 161.

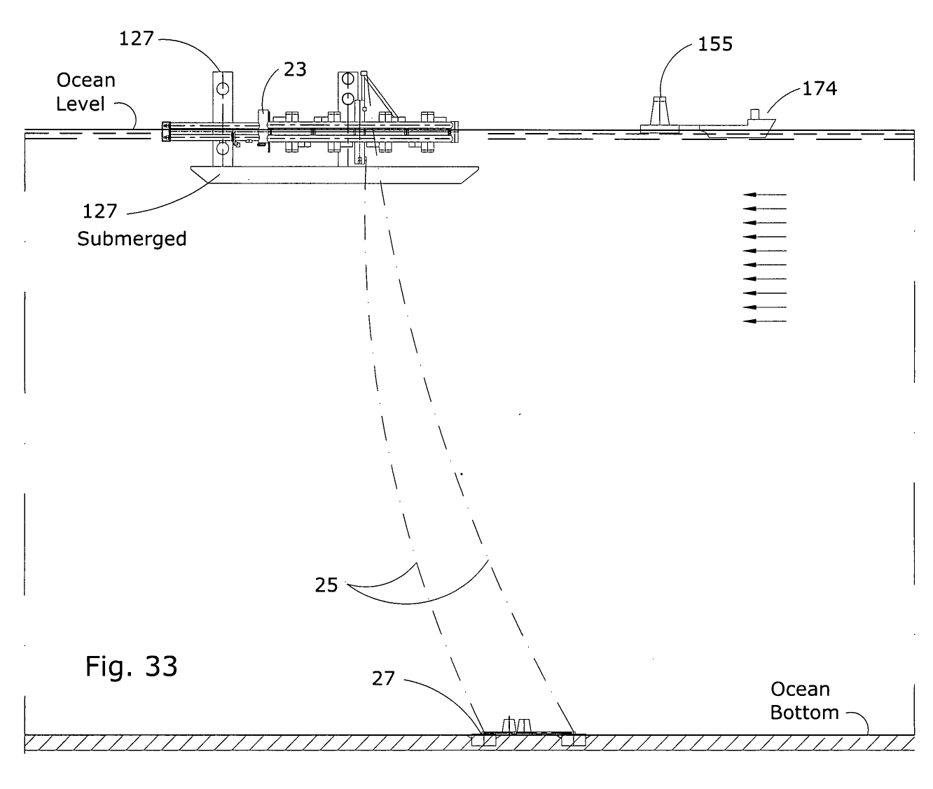

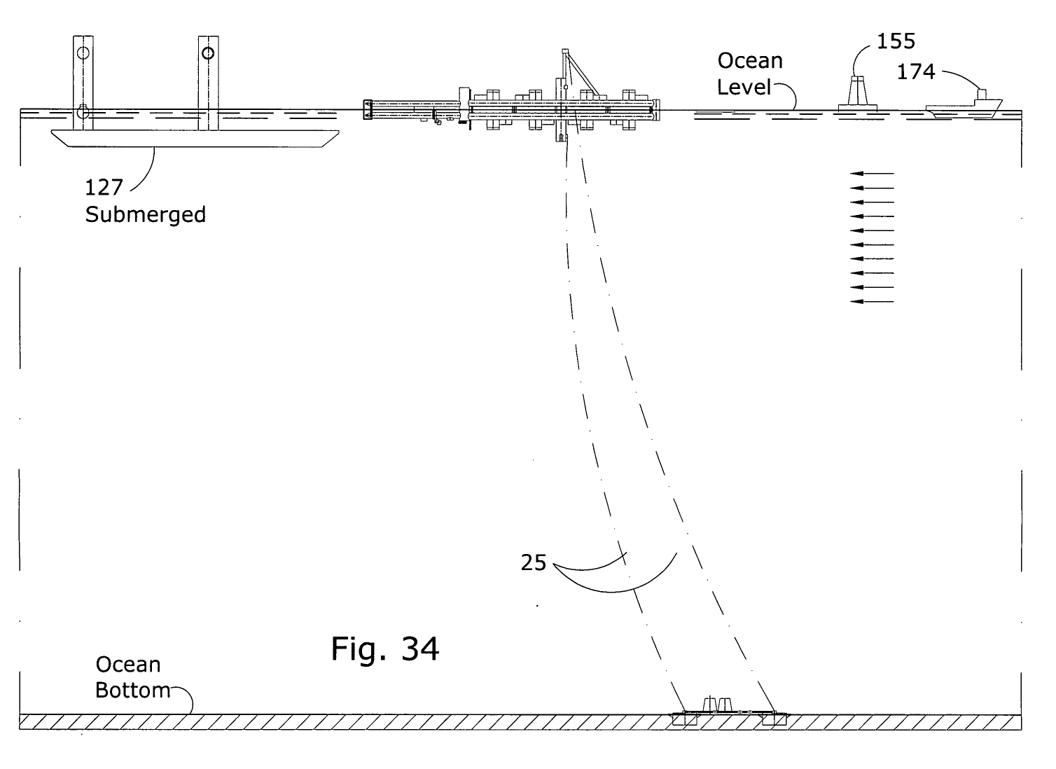

FIGS. 33 and 34 illustrate the process of Catamaran Delivery Barge 127 lowering Turbine Housing 23 in water and disengaging from it. During this process the Catamaran Delivery Barge 127 would take water ballast in its both of its pontoons 151 and by this it sink its pontoons 151 below ocean surface and on a distance that would lower Turbine Housing 23 in water. Stability of Catamaran Delivery Barge 127 would be provided by four extended columns 139 and 145, which put Catamaran Delivery Barge 127 into semisubmersible mode. The frame 33 of Turbine Housing 23, which is designed from pipes and hollow vessels, would provide sufficient buoyancy to float Turbine Housing 33 horizontally. After Turbine Housing 23 starts to float tugs 172 would let Catamaran Delivery Barge 127 to drift under their control down the current stream. Simultaneously the Turbine Housing 23 would also start to drift down the stream.

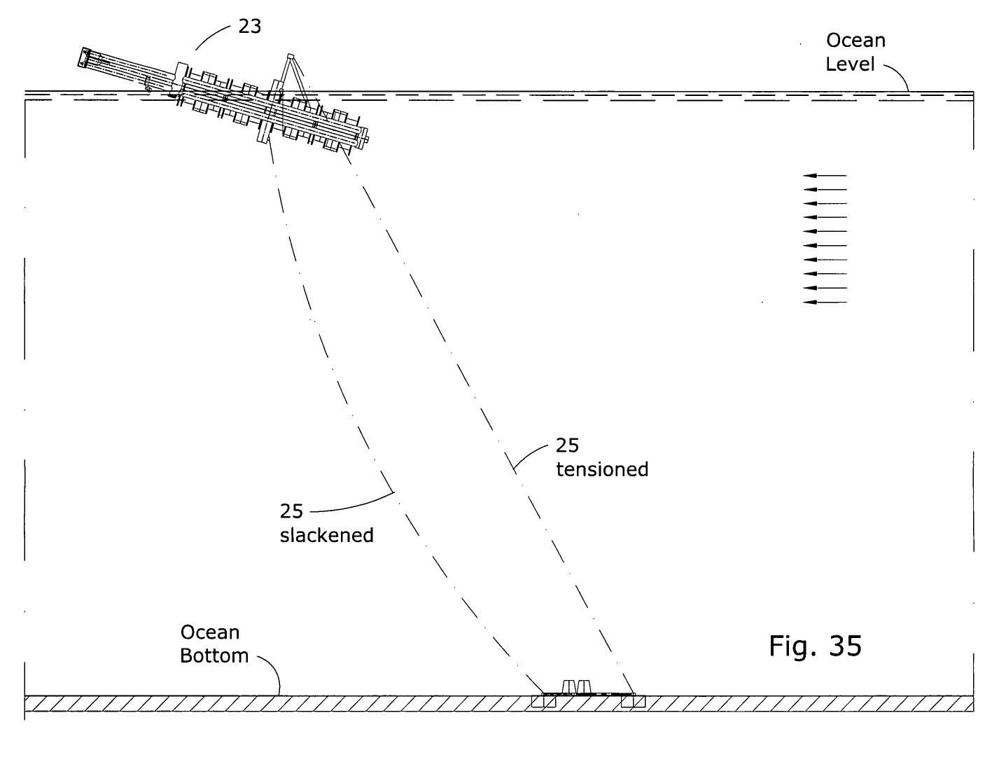

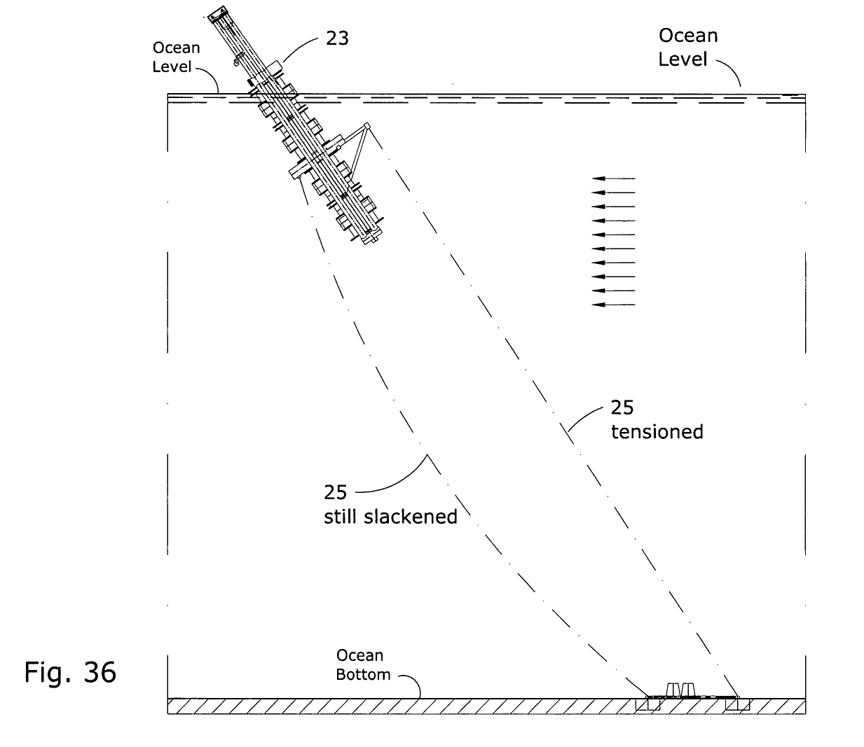

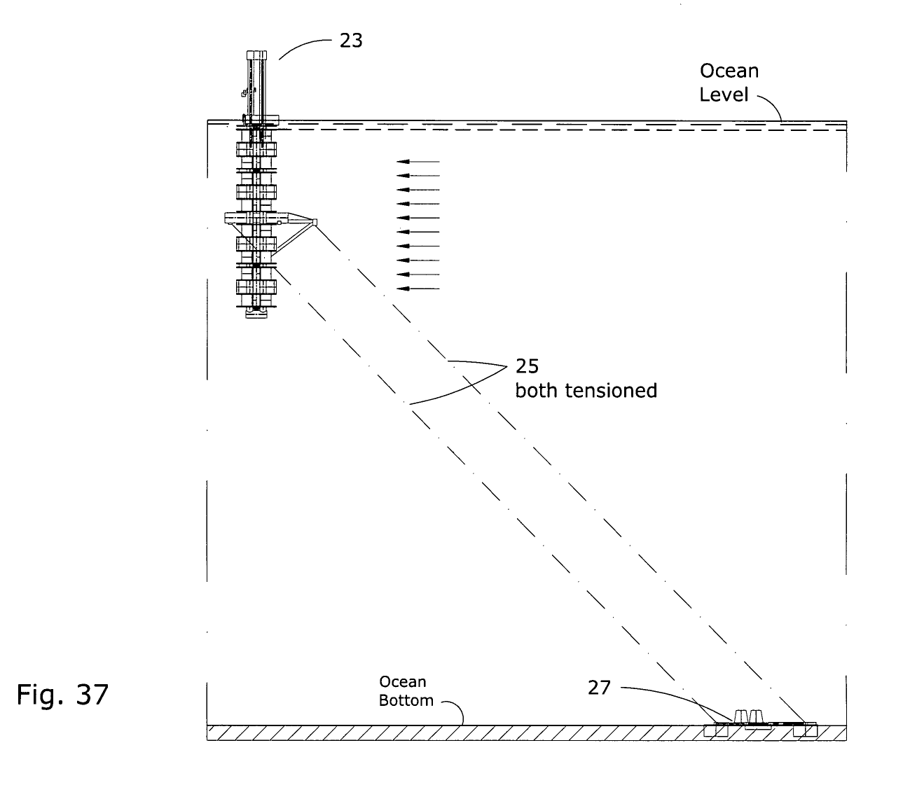

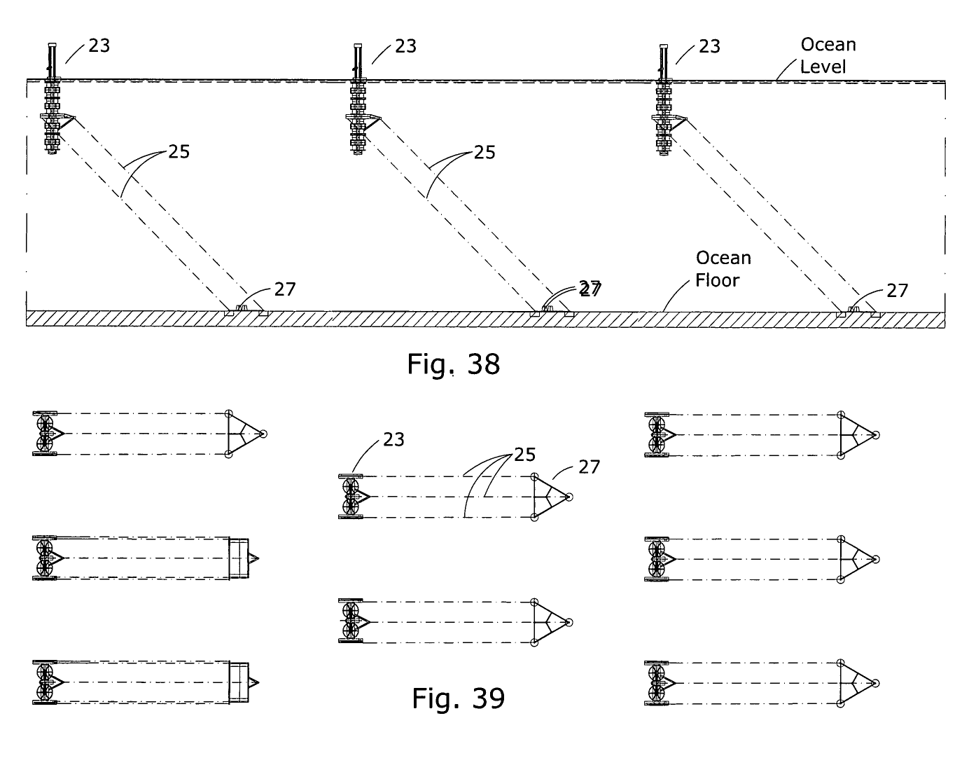

FIGS. 35 through 37 illustrated the process of Turbine Housing 23 inverting from horizontal position to vertical position under current force. It would be initiated by ballasting lower part of frame 33, which would initially slightly incline it and by this increasing area affected by current, which would start to turn Turbine Housing around a points to which one pair of tethers 25 are attached.

### Systems Servicing IHOC.

### Blade Cleaning System.

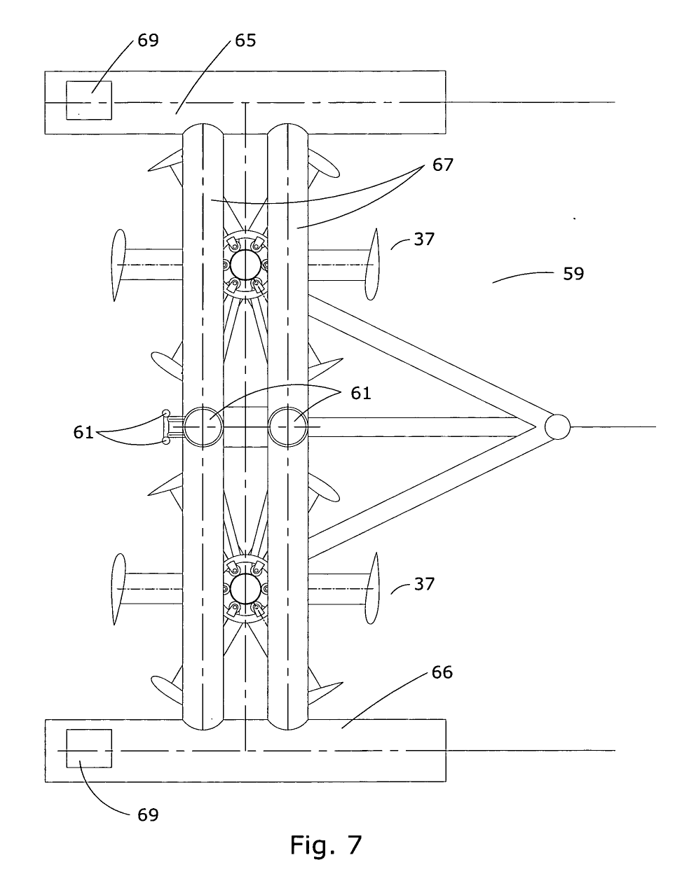

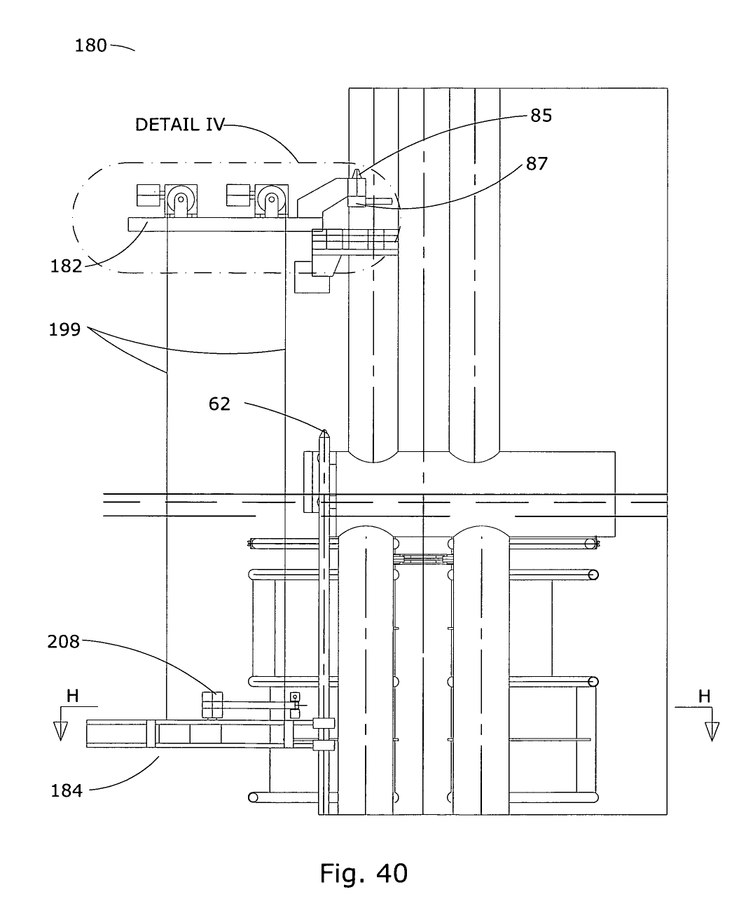

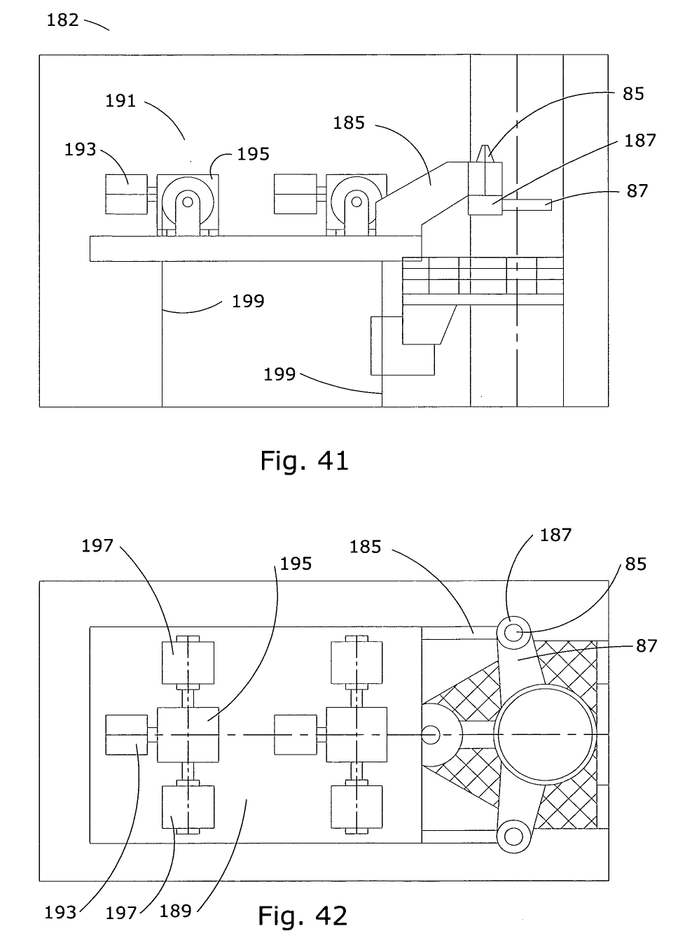

FIGS. 40 through 43 illustrate Blade Cleaning System 180 for cleaning turbine blades from foulings. It consists of winch platform 182 and operating platform 184. Winch platform 182 has, for the purpose of attaching to IHOC, two outreach legs 185 with bushings 187, which engage with guiding poles 85 (see FIG. 11). Outreach Legs 185 are attached to base 189 on which are located two winches 191. Each of the winch 191 consists of drive 193, gearbox 195 and two drums 197 with hoisting lines 199 winded up by one end on them and by other end connected to frame 201 of operating platform 184. Operating platform 184 consists of a frame 201 having two horizontal guides 203 and two sets of guiding rollers 205 embracing guiding rails 62 (see FIGS. 3 and 7). It also includes two blade cleaning machines 207 and 208. Each 207 and 208 machine consists of a base 209, two arms each having cleaning heads 211, 212 and hydraulic cylinders 213 and 212.

### Operation of Blade Cleaning System 180.

Floating Crane would bring to IHOC on its hook winch platform 182, which would have operating platform 184 suspended on four hoisting lines 199 as close as possible to winch platform. Than Floating Crane would lower winch platform 182 on IHOC in a manner that bushings 187 of winch platform 182 would come in contact with poles 85 through theirs cones, which would guide bushings 187 to rest on poles 85 supports 87. After this the winches 191 would start to pay out hoisting lines 191, which would start to lower operating platform 184.

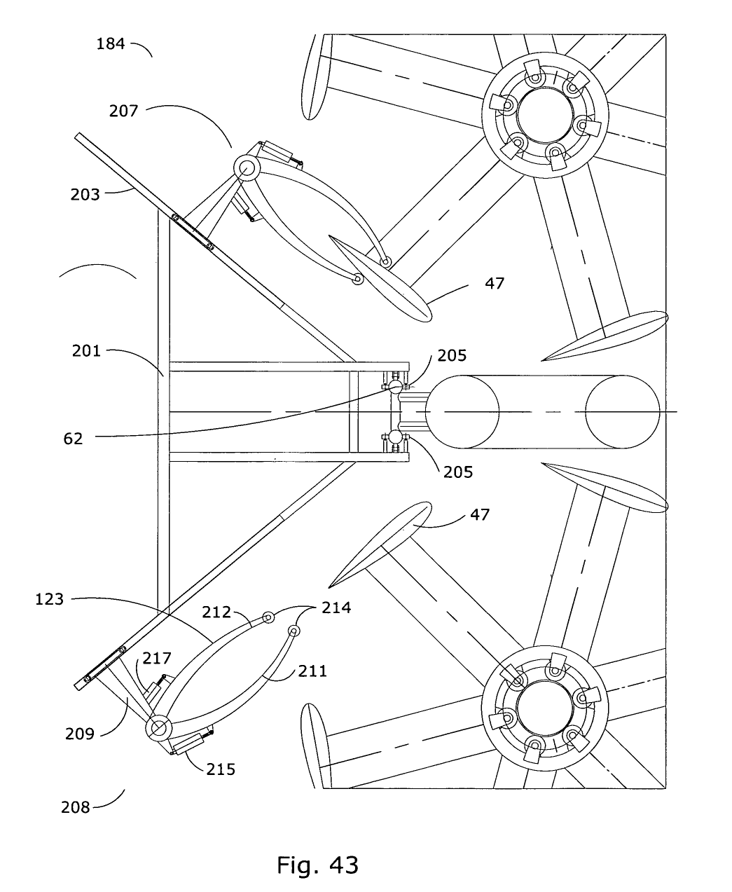

During the lowering process the two sets of guiding rollers 205 would get in contact with two guiding rails 62, which would prevent operating platform 184 from any horizontal movement under current and wave forces. When on the way dawn operating platform 184 reaches the first blade 47, both blade cleaning machines 207 and 208 would be in position in which cleaning machine 208 is shown on FIG. 43. When operating platform 184 stops, the blade cleaning machines 207 and 208 would start moving toward blades 47. After cleaning machines reach the blades 47, the hydraulic cylinders 215 and 217 would bring cleaning heads 214 in contact with blade 47 surface. During continue movement of cleaning machines along the blade 47 section the cleaning heads would clean a strip equal to their width. After cleaning heads 214 would get out of contact with blade 47, the operating platform would be lowered on a distance equal to the cleaned strip width. After these cleaning machines 207 and 208 would be pulled back and cleaning heads 214 would get in contact with blade 47 and on the way back would clean one more strip. This operation would be repeated until the vertical length of blade 47 would allow. (0038) When all blade's surface is cleaned, cleaning machines 207 and 208 would be retracted to their initial position and both row of Darrieus turbines 31 would be rotated on the angle between blades and a new cycle of blades 47 cleaning would start.

### Service Vessel.

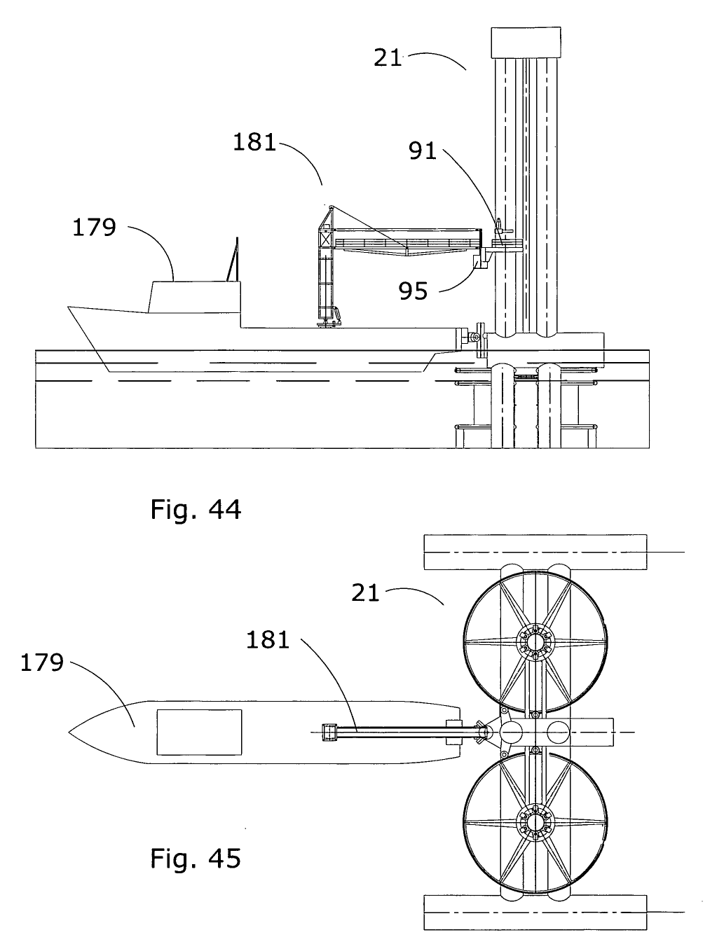

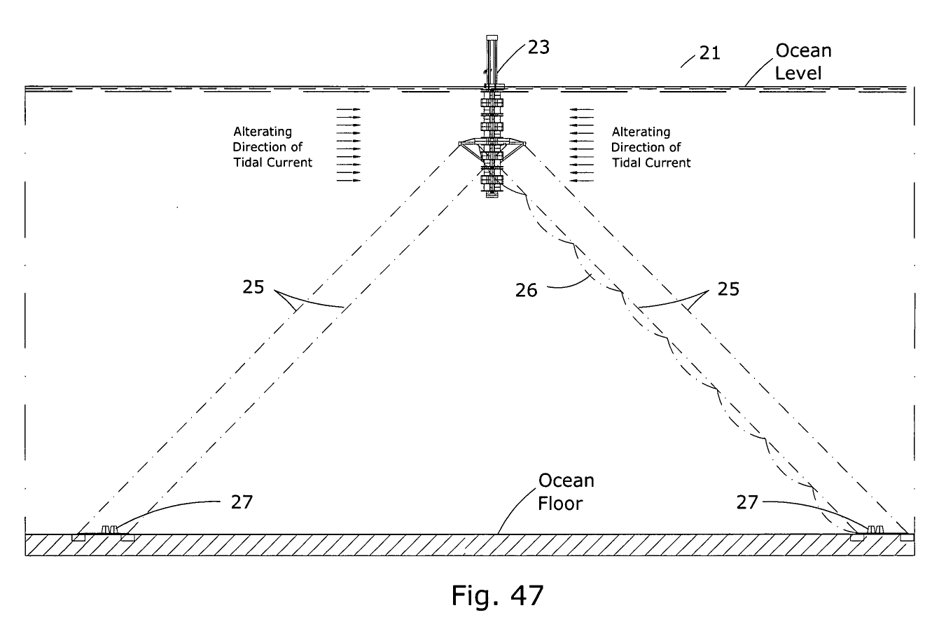

FIGS. 44 and 45 illustrates Service Vessel 179 engaged with IHOC 21 through Personnel Transfer Station 181 and cone-adapter 95 on IHOC 21.

### EMBODIMENT B

FIG. 47 Illustrates IHOC application for harvesting energy of tides in deepwaters. Because of Darrieus turbine capability to rotate in the same direction, regardless of current direction, design of IHOC for harvesting energy of tides differs from the design for harvesting energy of currents only by having two anchoring arrangement, each consisting of Anchoring Base 27 and set of tethers 25, located opposite to each other.

What is claimed:

1. Floating installation for converting kinetic energy of ocean current into electricity consisting of semisubmersible platform anchored to seabed and having submerged Turbine Housing containing two rows of vertical Darrieus type turbines and their machinery room with electric power generators located above water level and supported by vertical columns, comprising:
a mooring system consisting of three tethers of equal length, each said tether is attached by its upper ends to one of three points on the middle of said submerged Turbine Housing in a manner that these three points forms a triangle in the plane, which geometrical center coincides with the center of buoyancy of said submerged Turbine Housing, and each of said tether is connected by its lower ends to the three points of said anchoring base;
each of two points on said submerged Turbine Housing, to which tethers are attached, form the axis of said submerged Turbine Housing possible rotation under outer forces action;
said anchoring base has corresponding triangle form with suction buckets on the tips of triangle and a frame interconnecting them in one structure;
said frame has three cones for temporally storage of said tethers;
a system for controlling buoyancy force of said submerged Turbine Housing utilizes some part of the hollow space of pipes, which form said Turbine Housing, as a constant buoyancy volume, some part of said hollow space as a permanent storage for compressed air and some part of said hollow space as a mix of the volumes of water and compressed air above it, which could be controlled, thus allowing to keep turbines positioned near ocean surface regardless of changing force of the current and to lower them significantly below water level during severe storms;
Anchoring Base;
means for providing maintenance personnel access to IHOC during stormy seas;
means for periodic cleaning the turbine blades surface from foulings.

2. Floating Installation by claim 1, wherein said Anchoring Base, comprising:
three suction buckets interconnected by a frame forming triangle,
each of said suction bucket has on its upper part a suction pump with the capability to be disconnected from said suction bucket and flow up to the ocean surface,
three cones located near center of said formed triangle serving as a temporally storage for said tethers.

3. Floating Installation by claim 1, wherein said means for providing maintenance personnel access to IHOC during stormy seas comprising:
a base consisting of boarding platform and at least three equally spaced cone-adapters, which allow the special Service Vessel gangway to be engaged with them.

4. Floating Installation by claim 1, wherein said means for periodic cleaning of the turbine blades surface from foulings comprising:
a Blade Cleaning System consisting of winch platform and operating platform,
said winch platform consists of:
two outreach legs, through which it is engages with guiding poles on said Turbine Housing,
a base on which are mounted two winches, each having drive, gearbox and pair of drums with hoisting lines;
said operating platform consist of a frame and pair of blade cleaning machines;
said frame has two sets of guiding roles, which are engaged with guiding rails on said Turbine Housing, and two horizontal guiders for said blade cleaning machines;
each of said cleaning machine consists of a base, two hydraulically operated arms each having on its end a cleaning head.

5. Means and method for transporting Installation for Harvesting Ocean Current from Assembly Yard to destination site and installing it there, comprising;
means for transporting IHOC from Assembly Yard to destination site includes, three carriages, three piers, Catamaran Delivery Barge and Stabilizing Platform;
method of transporting IHOC from Assembly Yard to destination site includes the following steps:
moving assembled Turbine Housing, installed on three carriages, from Assembly Yard to three piers,
towing Catamaran Delivery Barge having additional ballast toward Turbine Housing installed on three piers in a manner that its three points of contact with Turbine Housing three points would pass under them and as soon they will fully match each other stops,
pumping ballast from Catamaran Delivery Barge leads to it rise and by this it lifts Turbine Housing from carriages,
flowing out from piers in open sea,
forming a Convoy from Catamaran Delivery Barge with Turbine Housing on it, Anchoring Base, which floats on its suction buckets air cushions, and Stabilizing Platform,
during formation of Convoy three tethers from Anchoring Base would be connected to Turbine Housing connection points and hoisting line together with power cable from Stabilizing Platform are connected to Anchoring base;
after formation of Convoy is completed it is towed by at least two group of tugs to destination site;
at the destination site the Anchoring Base is lowered to seabed by letting compressed air out of suction buckets and by controlling its decent through a hoisting line and a winch on Stabilizing Platform,
about 10 meters before reaching the seabed, winch on Stabilizing Platform stops paying out hoisting line, which leads Stabilizing Platform to sink and by this increasing force controlling Anchoring Base horizontal position;
after Anchoring Base reaches the seabed the tension in hoisting line is released and Anchoring Base under its own weight partially penetrates into seabed soil and suction pumps on suction buckets are activated and this further increasing penetration of suction buckets into soil,
after suction buckets are fully inserted in soil the suction pumps flow up and hoisting line is retreated by winch to Stabilizing Platform;
at this moment Catamaran Delivery Barge takes ballast, sinks into a semisubmersible mode and moves out of connection with floating Turbine Housing,
inverting floating Turbine Housing from horizontal position to vertical starts by taking ballast in its lower part,
when Turbine Housing reaches vertical position all tethers would be equally tension by current and by this installation of IHOC is completed.

6. Means and method for transporting Installation for Harvesting Ocean Current by claim 5, wherein said Catamaran Delivery Barge, comprising:
two pontoons having on their rear end and near the middle extended upward columns,
said extended upward columns on the rear ends of said pontoons are interconnected by two crossbeams, one upper and one lower,
said extended upward columns near the middle of said pontoons are interconnected only by one upper crossbeam,
three points of contact with said Turbine Housing,
one point of said contacts is in the form of a support pillow located in the middle of said lower crossbeam interconnecting two said extended columns on the rear part of said pontoons,
two points of said contacts are in the form of support stools located on said pontoons in area near said extended upward columns,
compressors and controls posts located inside said extended columns.

7. Means and method for transporting Installation for Harvesting Ocean Current by claim 5, wherein said Stabilizing Platform, comprising:
pontoon,
platform,
a winch on said platform having hoisting line with its quick release devise,
an electric power cable drum with cable,
an electric power generators and control post,
for legs connecting said pontoon with said winch platform.

8. Floating installation for converting kinetic energy of ocean tides in deepwaters into electricity consisting of semisubmersible platform anchored to seabed and having Turbine Housing containing two rows of vertical Darrieus type turbines and their machinery room with electric power generators located above water level and supported by vertical columns, comprising:
a pair of mooring system attached to said Turbine Housing from opposite sides each consisting of three tethers of equal length and attached by their upper ends to the three points of contacts located in the middle and on the opposite sides of said submerged structure containing two rows of vertical Darrieus turbines in a manner that these three points forms a triangle, which geometrical center coincides with the center of buoyancy of said submerged structure containing two rows and by their lower ends to the anchoring base;
each of two points, to which tethers are attached, form the axis of said Turbine Housing possible rotation under outer forces action;
said anchoring base has corresponding triangle form with suction buckets on the tips of triangle and a frame interconnecting them in one structure;
said frame has three cones for temporally storage of said tethers;
a system for controlling buoyancy force of said Turbine Housing containing two rows of vertical Darrieus turbines utilizing part some of the hollow space of pipes, which forms the said Turbine Housing, as constant buoyancy volume, some as a permanent storage for compressed air and some as a space at which the volume of water and compressed air above it can be controlled, thus allowing to keep turbines positioned near ocean surface regardless of changing force of the current and to lower them significantly below water level during severe storms;
means for providing maintenance personnel access to IHOC during stormy seas;
means for periodic cleaning the turbine blades surface from foulings.
